(19) United States
(12) Patent Application Publication
(10) Pub. No.: US 2019/0310124 A1
(43) Pub. Date: Oct. 10, 2019

(54) WATER METERING SYSTEM WITH PIGGY BACKED E-COMMERCE

(71) Applicant: RYNAN TECHNOLOGIES PTE. LTD., SINGAPORE (SG)

(72) Inventors: MY T. NGUYEN, Tra Vinh City, Tra Vinh Province (VN); LUONG V. TRUONG, Chau Thanh District, Tra Vinh Province (VN); CUONG Q. HONG, Tra Vinh City, Tra Vinh Province (VN); AN TRINH, Tra Vinh City, Tra Vinh Province (VN); TRIEU T. LE, Hon Dat District, Kien Giang Province (VN); THONG A. NGUYEN, Tra Vinh City, Tra Vinh Province (VN); KHANG M. DUONG, Ninh Kieu District, Can Tho City (VN); TOAN Q. TRAN, Cang Long District, Tra Vinh Province (VN); HIEN H. NGUYEN, Long My District, Hau Giang Province (VN); BIEN T. MAI, Cau Ke District, Tra Vinh Province (VN)

(21) Appl. No.: 16/314,797

(22) PCT Filed: Nov. 22, 2016
(86) PCT No.: PCT/CA2016/051363

§ 371 Date: Jan. 2, 2019

Related U.S. Application Data
(60) Provisional application No. 62/373,026, filed on Aug. 10, 2016.

(51) Int. Cl. G01F 15/06; G06Q 50/06; G06Q 30/06; H04W 4/80; G01F 1/075

(52) U.S. Cl. CPC G01F 15/063; G06Q 50/06; G01F 1/075; H04W 4/80; G06Q 30/0641

(57) ABSTRACT

A water meter/e-commerce is disclosed wherein a wide area network (WAN) and an application on a smartphone or the like can be used to retrieve a measured water consumption from a water meter while accessing an e-commerce system. The application displays the retrieved water consumption together with at least one product, and further wherein the at least one product may be purchased from the e-commerce system using the application.

### FIELD OF THE INVENTION

The present invention relates to a water metering system with piggy backed e-commerce.

### BACKGROUND TO THE INVENTION

In order to better control the use of fresh water, water meters have been installed in buildings and residences. One drawback is that such prior art water meters are mechanical and may only be read locally by via a dial or attaching an appropriate reader. Installation of new networked meters is expensive for both the utilities, who wish to have an accurate view of actual consumption to provide detailed, and users who better wish to understand their own consumption as well as the costs involved.

### SUMMARY OF THE INVENTION

In order to address the above, there is provided a water metering system with piggy backed e-commerce. The system comprises a water utility comprising a water consumption data collection server comprising circuitry for communicating via a wide area network, an e-commerce system selling at least one product and comprising circuitry for communicating via the wide area network, a water utility infrastructure comprising a water mains supplying water under pressure to a plurality of locations of water consumption, a plurality water meters, one of the water meters attached along the water mains at each of the locations of water consumption, each of the water meters comprising a meter for measuring water consumption, circuitry for communicating via a near field network, circuitry for communicating via the wide area network, a controller and a memory for storing the measured water consumption, wherein the measured water consumption is transferred from time to time to the water consumption data collection server via the wide area network, and a plurality of hand held user devices each comprising circuitry for communicating via the wide area network and an application for communicating with an accessible one of the water meters using the wide area network. Using the wide area network, the application retrieves the measured water consumption of the accessible water meter and accesses the e-commerce system via the wide area network, the application displaying the retrieved water consumption together with the at least one product, and further wherein the at least one product may be purchased from the e-commerce system using the application.

There is also provided a water meter for metering water flowing from a water main to a water distribution system and communicating with a water consumption data collection server via a wide area network. The water meter comprises a solar powered power source, an inlet connected to the water mains, an outlet connected to the distribution system, an impeller positioned between the inlet and the outlet wherein a speed of rotation of the impellor varies as a function of a water flow rate between the inlet and the outlet, a sensor for measuring the speed of rotation, circuitry for communicating via the wide area network, and circuitry for converting the speed of rotation into a measured water consumption wherein the measured water consumption is transferred from time to time to the water consumption data collection server via the wide area network.

### BRIEF DESCRIPTION OF THE DRAWINGS

FIG. 1 provides a schematic diagram of a water metering system with piggy backed e-commerce in accordance with an illustrative embodiment of the present invention;

FIGS. 2A and 2B provide respectively raised left and lowered right perspective views of a water meter in accordance with an illustrative embodiment of the present invention;

FIG. 3 provides an exploded view of a water meter in accordance with an illustrative embodiment of the present invention;

FIGS. 4A and 4B provide exploded views of an impeller assembly in accordance with an illustrative embodiment of the present invention;

FIGS. 5A and 5B provided respectively top plan and bottom plan views of a printer circuit board in accordance with an illustrative embodiment of the present invention;

FIG. 6 provides a schematic diagram of a water meter in accordance with an illustrative embodiment of the present invention; and

FIGS. 7A through 7D screen grabs of a combined water consumption/e-commerce application in accordance with an illustrative embodiment of the present invention.

### DETAILED DESCRIPTION OF THE ILLUSTRATIVE EMBODIMENTS

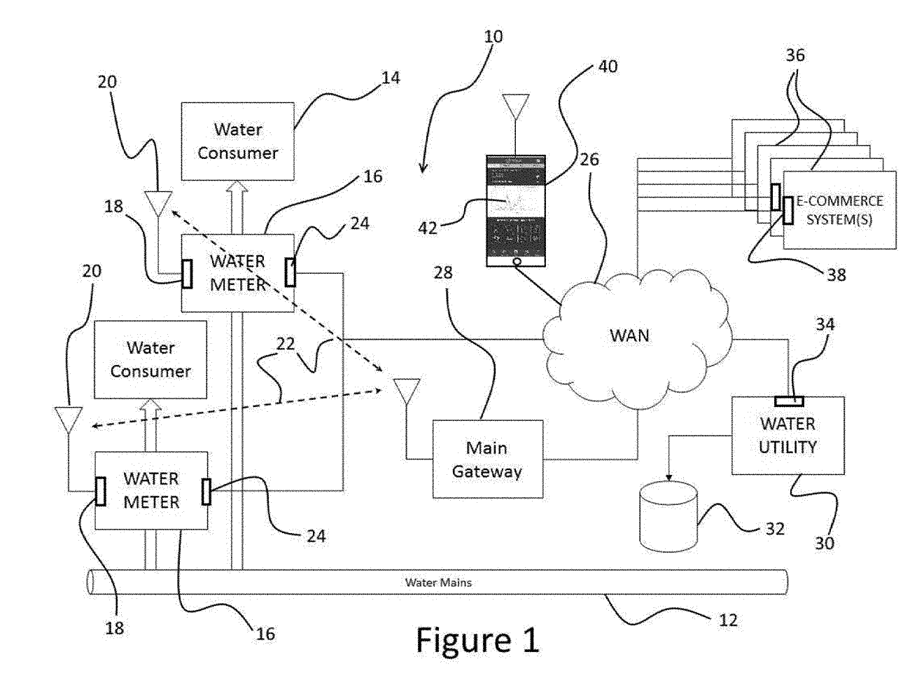

Referring now to FIG. 1, a water metering system with piggy backed e-commerce, and generally referred to using the reference numeral 10, will now be described. A water main 12 provides water under pressure to a plurality of water consumers 14 at a location of water consumption, such as a residence, building or business or the like (not shown) via a respective water meter 16. Each water meter may comprise network circuitry 18, for example a nearfield network such as RF or Bluetooth and/or WiFi, including an associated antenna 20 for communicating via an RF/Bluetooth/WiFi LAN 22 and wide area network circuitry 24 for communicating via a Wide Area Network (WAN) 26 such as the internet or like. In this regard, the wide area network circuitry can include for example a cellular modem (not shown) for accessing the wide area network 26 via a GSM/GPRS/GPS type connection. In an alternative embodiment, access to the WAN 26 is provided to a plurality of water meters (for example in multi-unit housing or the like) via the RF/Bluetooth/WiFi LAN 22 and a main gateway 28.

Still referring to FIG. 1, a water utility 30 comprises a water consumption data collection server and a data store 32 and wide area network circuitry 34 for communicating via the WAN 26 is interconnected to the water meters 16 via the WAN 26, to which are also attached at least one e-commerce system 36, also comprising wide area network circuitry 38 for communicating via the WAN 26, and selling products (not shown). A plurality of hand held devices 40, such as a smartphone or tablet or the like, each executing an application 42, communicate with an accessible one of the water meters 16 via the WAN 26.

Still referring to FIG. 1, the water utility 30 collects from time to time data on water consumption from the water meter 16 via the WAN 26. This data may be stored in the data store 32 for analysis purposes and billing and the like. Additionally, a user may access a local water meter 16 using a suitably equipped hand held device 40 including the application 42 and via the WAN 26 to retrieve information on local water consumption from the water meter 16.

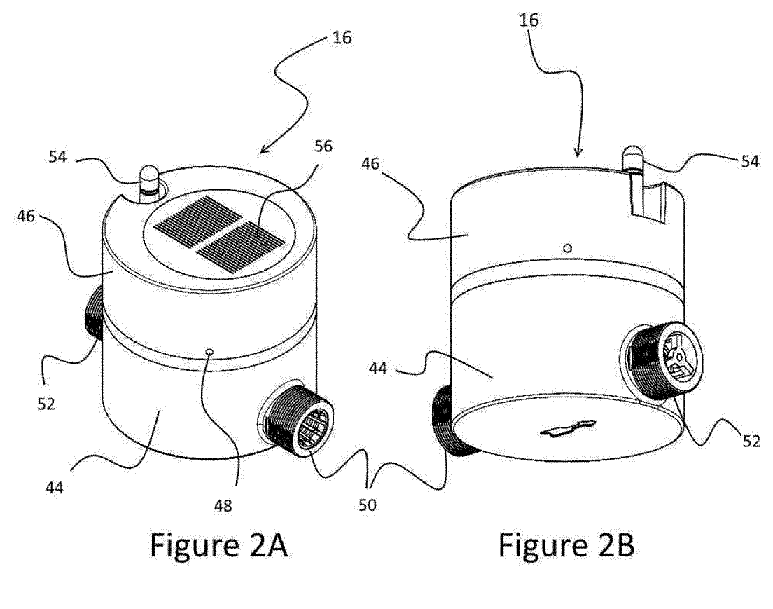

Referring now to FIGS. 2A and 2B, the water meter 16 comprises a housing comprising a lower part 44 and an upper part 46 which is secured to the lower part 44 by a plurality of lock screws 48. The water meter 16 illustratively further comprises an inlet 50 for connection to a water supply under pressure (not shown), an outlet 52 for connection to the water distribution piping of a building or the like (also not shown), an antenna 54 and a power source such as a solar panel 56. In an alternative embodiment, and as will be discussed in more detail below, the water meter 16 can be powered by an external source such as mains current or the like and using a suitable adaptor.

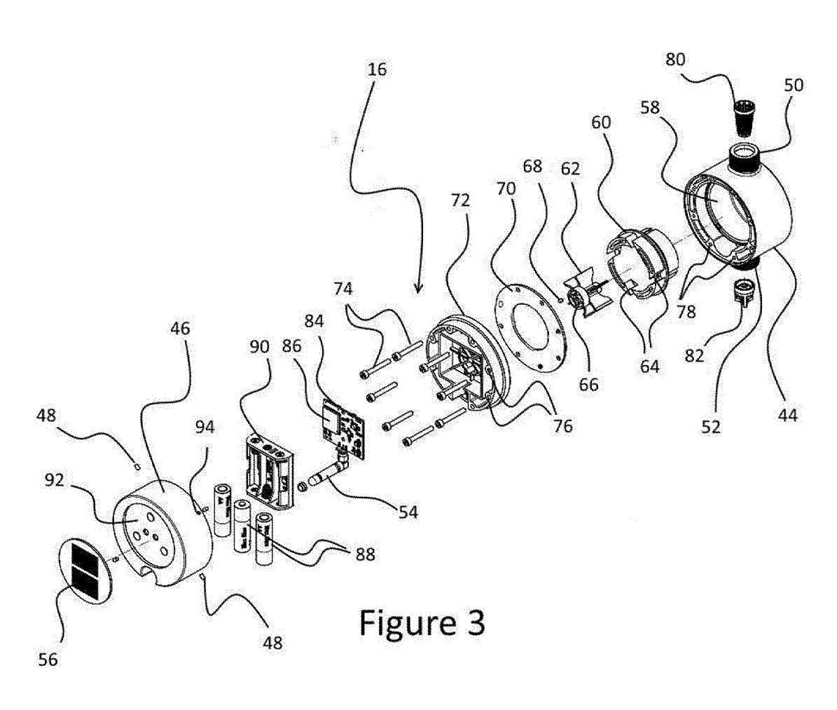

Referring now to FIG. 3 in addition to FIGS. 2A and 2B, a hollow space 58 in the lower part 46 of the water meter 16 receives a water flow directing insert 60 and an impeller assembly 62 therein. The water flow directing insert 60 comprises a plurality of channels 64 which guide water flowing between the inlet 40 and outlet 52 over the impeller 62 and such that the impeller assembly 62 rotates. The impeller assembly 62 comprises a collar 66 which rotates about an impeller axis therewith and into which a magnet 68 is mounted of axis. The water flow directing insert 60 and impeller assembly 62 are sealed within the hollow space 58 by a gasket 70 and an intermediate cover 72. The intermediate cover 72 and gasket 70 are secured to the lower part 46 by a plurality of bolts 74 which are inserted through respective ones of a plurality of bores 76 in the intermediate cover 72 and engage receptive ones of a plurality of threaded bores 78 in the lower part 46. Illustratively a strainer 80 is inserted into the inlet 50 to capture dirt and the like which might otherwise for example foul the impeller 62 assembly. Additionally, a flow check valve 82 can be provided on the outlet to ensure that the water meter 16 will not operate if incorrectly attached between the water mains and distribution network (both not shown).

Still referring to FIG. 3, the upper part 48 of the water meter 16 covers a printed circuit board (PCB) 84 which is secured to the intermediate cover 72 by a plurality of screws or the like (not shown) and on which, as will be discussed in more detail below, electronics 86 are placed. The electronics 86 sense rotation of the impeller assembly 62 via the magnet 68 and a sensor element such as a read switch or hall effect device or the like (not shown) mounted on the PCB 84. The electronics 86 are also interconnected with the antenna 54 and a source of power such as one or more rechargeable batteries 88 or the like which are illustratively held in a carrier 90. The electronics 86 are also illustratively interconnected with the solar panel 56 which is held within in a depression 92 in the outer surface of the upper part. In this regard, the electronics 86 would typically include circuits (not shown) for regulating an output of the solar panel 56 as well as circuits (also not shown) for recharging the one or more batteries 88 (such as AA type batteries as shown). Additionally, and as will be discussed below, a power supply such as a 5V DC adaptor attached to the electrical mains may also be used in a particular embodiment to power the water meter 16. As discussed above, the upper part 46 may be secured to the lower part via a plurality of locking screws 48 which are received in respective ones of a plurality of threaded bores 94 in the upper part 46.

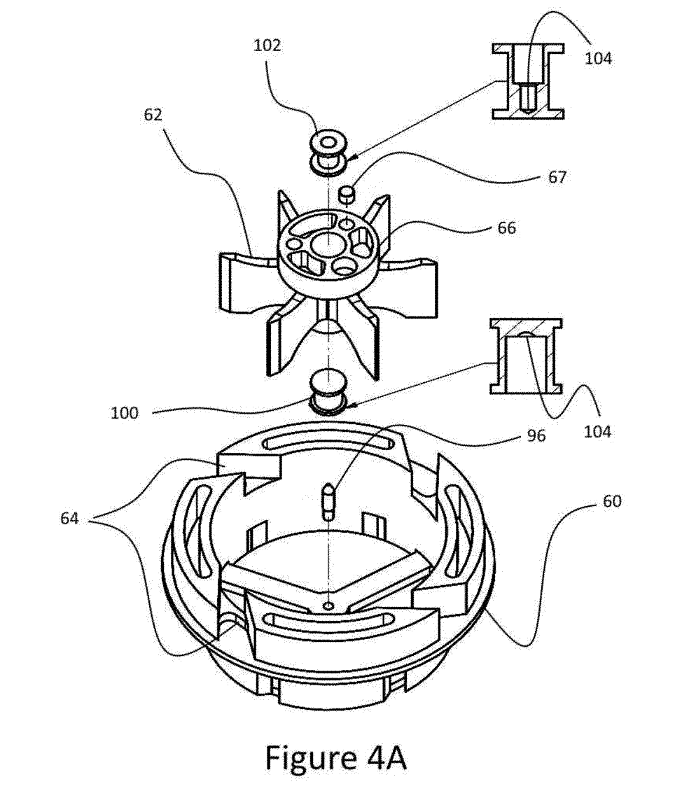

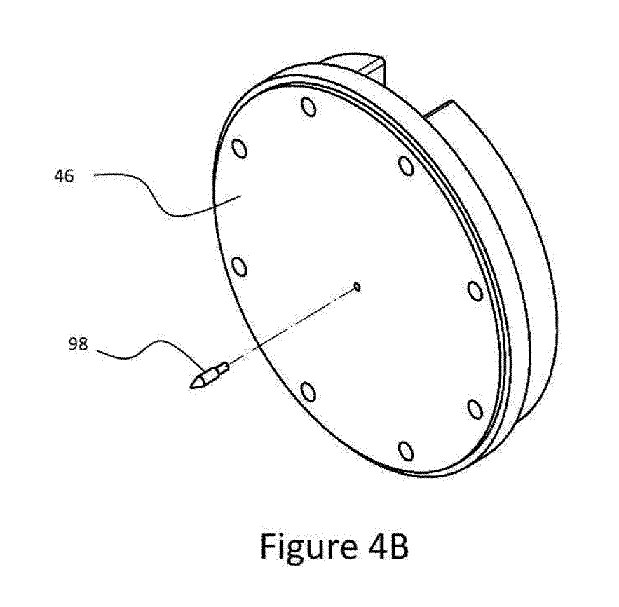

Referring now to FIGS. 4A and 4B, the assembly of the impeller 62, collar 66 and magnet 68 is suspended between a pair of opposed precision pivots 96, 98 secured to a respective one of the water flow directing insert 60 and the intermediate cover 72 and which are engaged in respective bearing terminal inserts 100, 102 in the impeller 62. The surfaces 104 of the bearing terminals 100, 102 engaged by the precision pivots 96, 98 may be surfaced in a resilient material such as ruby or the like in order to reduce friction and increase durability.

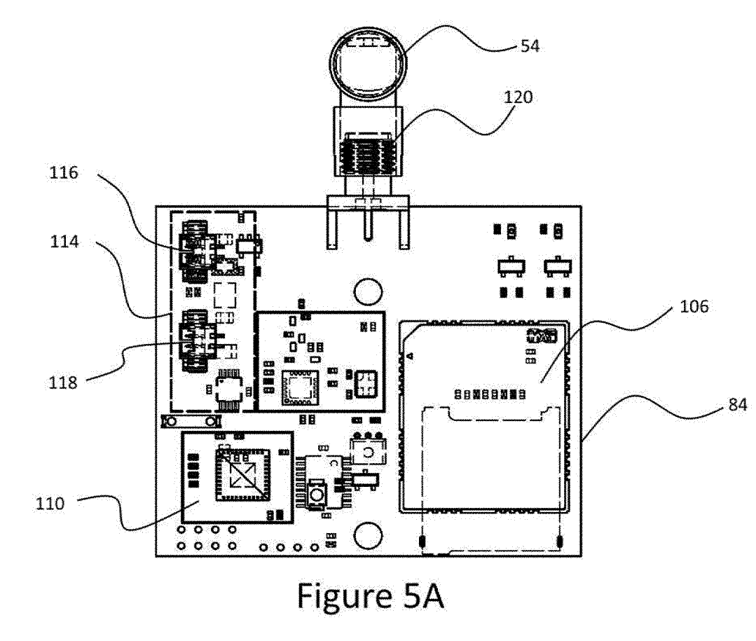

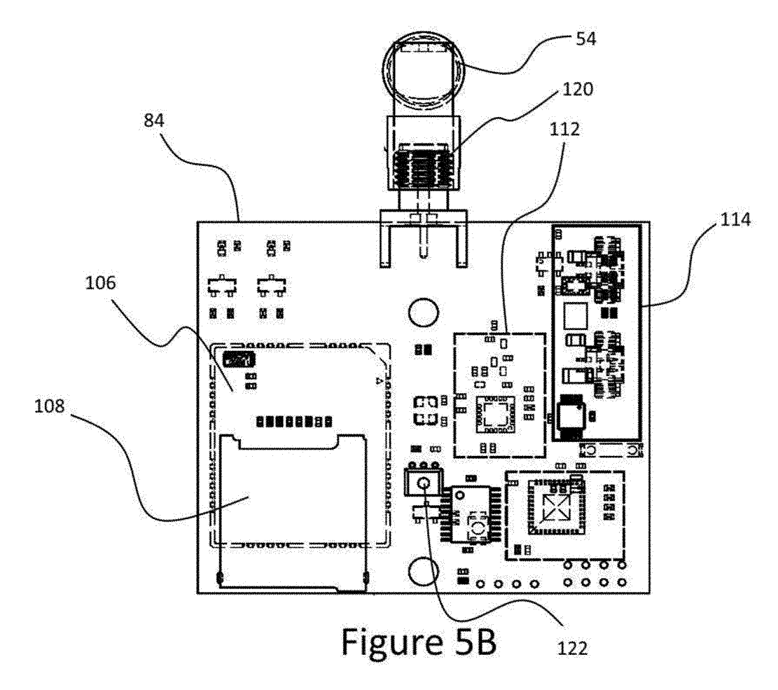

Referring to FIGS. 5A and 5B, an illustrative example of the PCB 84 is provided comprising electronics 86 such as a GSM/GPRS/GPS module 106 and receptacle 108 for receiving a SIM card are shown. Other electronics illustratively include a microcontroller 110, an RF module 112, a power conditioning circuit 114, a solar panel connector 116 and a battery source connector 118. An antenna connector 120 is also provided to attached the electronics 86 to the antenna 54. Additionally, a sensor 122 is provided for sensing the magnet 68 imbedded in the impeller 62.

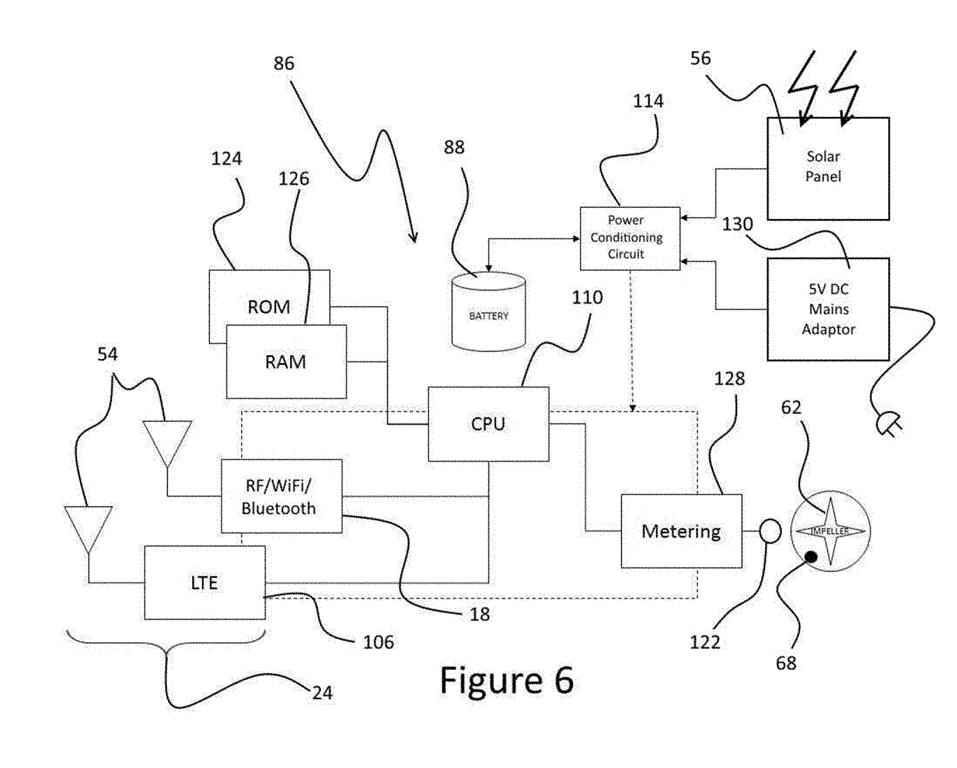

Referring now to FIG. 6, as discussed above the electronics 86 comprise a microcontroller (CPU) 110 which using programs and settings illustratively stored on a Read Only Memory (ROM) 124 and or Random Access Memory (RAM) 126 collects readings from a metering module 128. In this regard the metering module 128 illustratively comprises the impeller 62 which as discussed above is situated in the water flow and the magnet 68 as well as the sensor 122. Collected flow rates are illustratively stored in the RAM 124 for example for future use and analysis. As discussed above, the water meter 16 is illustratively powered by a solar panel 56 which is fed into the power conditioning circuit 114, and additionally supplies the rechargeable battery 88 and such that the water meter 16 may continue to operate in times of low sunlight or at night. As discussed above, in a particular embodiment and external power supply 130 is provided, attached to the electrical mains (not shown) and illustratively outputting five (5) volts DC. Also as discussed above, the water meter 16 further comprises the RF module 112 including an associated antenna 54 for communicating via the LAN 22 such as RF, Bluetooth or WiFi or the like as well as a GSM/GPRS/GPS module 106 for communicating via the WAN 26 as well as, in a particular embodiment, determining a location of the water meter 16. In this regard, the GSM/GPRS/GPS module 106 comprises circuitry for accessing a digital cellular network, such as an LTE network, as well as an associated antenna 54. In a particular embodiment the water meter 16 is provided with a SIM card having a unique identification which can be associated, for example, with a user account. Users using a suitably equipped smartphone can communicate with a respective water meter 16 via a communication link established in part using the SIM card. Alternatively, and as discussed above, the water meter 16 can communicate with WAN 26 via the LAN 22 and a gateway. In order to enable simplify communications via the WAN 26, software comprising a TCP/IP telecommunications stack (not shown) can be provided, for example stored in memory such as the RAM 124. Additional software may be provided to allow the water meter 16 to act as a web server (also not shown) and such that a user may communicate directly via the water meter 16 using a smartphone, tablet, personal computer or the like equipped with suitable internet access and a web browser.

Referring back to FIG. 1 in addition to FIG. 6, using programs stored in ROM 124 and/or RAM 126, the CPU 110 is also able to relay or translate commands, data and other communications received via the near field network 22 to the WAN 26 and such that using the application 42 the hand-held device 40 may transact directly with one or other of the e-commerce systems 36 as well as with the water utility 30, for example to retrieve information related to billing or the like.

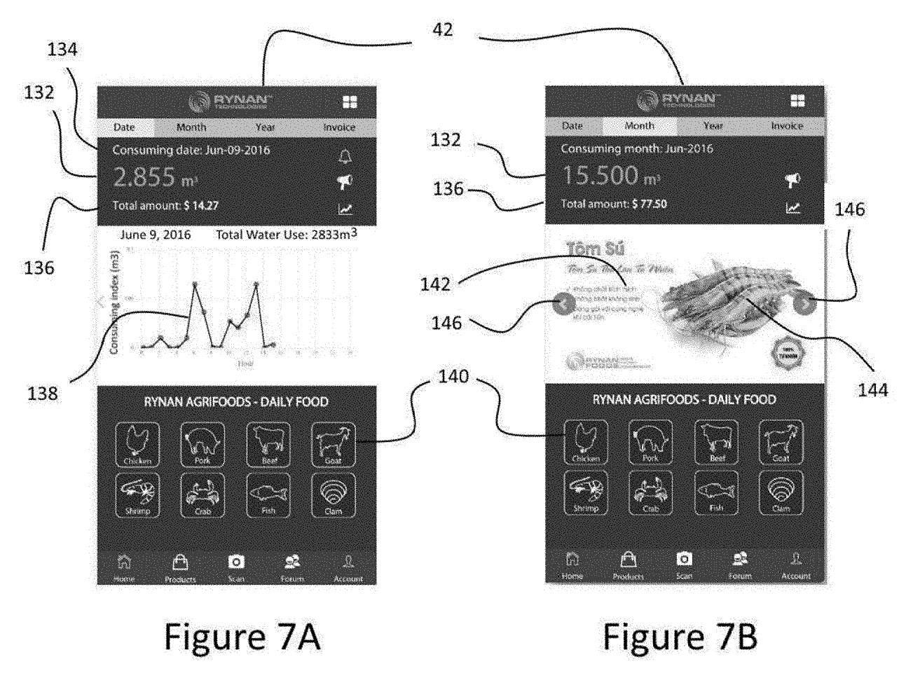

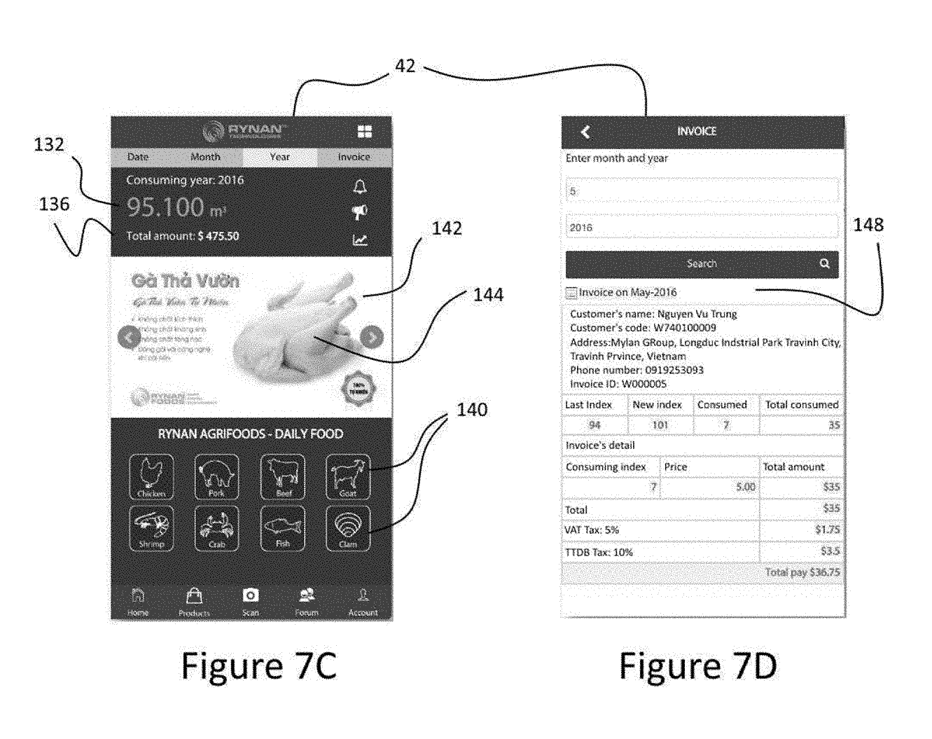

Referring now to FIG. 7A in addition to FIG. 1, as discussed above the hand held user device 40 comprises an application 42 for displaying water consumption 132, for example for a given day 134 and including the amount 136 the utility will charge for the water use. Diagnostic charts 138 and other graphics may be provided to aid the user in understanding his water consumption over the selected period of time. Icons 140 listing product categories available from an e-commerce system 36 are also displayed thereby providing the user with convenient access to the e-commerce system. Referring to FIGS. 3B and 3C other time periods, such as monthly (FIG. 3B) and yearly (FIG. 3D), as well as the corresponding costs for water usage 68 may also be displayed. Additionally, graphics 142 depicting products 144 for purchase via the e-commerce system may displayed as well as appropriate graphical controls 146 to migrate between different products.

Referring to FIG. 7D in addition to FIG. 1, the e-commerce system 36 also illustratively comprises a check-out and payment system (not shown) accessible via the application 42 for the generation and payment of invoices 148 made for the purchase of products 144 on the e-commerce system 36.

In particular embodiment, and for example in an implementation as discussed above where the water meter 16 is equipped to act as a web server, the user may access the pages of 7A through 7B via a web site, for example located on a suitably equipped water meter 16 using a web browser.

Although the present invention has been described hereinabove by way of specific embodiments thereof, it can be modified, without departing from the spirit and nature of the subject invention as defined in the appended claims.

We claim:

1. A water metering system with piggy backed e-commerce, comprising:
a water utility comprising a water consumption data collection server comprising circuitry for communicating via a wide area network;
an e-commerce system selling at least one product and comprising circuitry for communicating via said wide area network;
a water utility infrastructure comprising a water mains supplying water under pressure to a plurality of locations of water consumption;
a plurality water meters, one of said water meters attached along said water mains at each of said locations of water consumption, each of said water meters comprising a meter for measuring water consumption, circuitry for communicating via a near field network, circuitry for communicating via said wide area network, a controller and a memory for storing said measured water consumption, wherein said measured water consumption is transferred from time to time to said water consumption data collection server via said wide area network; and
a plurality of hand held user devices each comprising circuitry for communicating via said wide area network and an application for communicating with an accessible one of said water meters using said wide area network;
wherein, using said wide area network, said application retrieves said measured water consumption of said accessible water meter and accesses said e-commerce system via said wide area network, said application displaying said retrieved water consumption together with said at least one product, and further wherein said at least one product may be purchased from said e-commerce system using said application.

2. The water metering system of claim 1, wherein each of said plurality a water meters further comprises a solar powered power source.

3. The water metering system of claim 1, wherein each of said plurality a water meters further comprises a mains power supply.

4. The water metering system of claim 1, wherein said near field network is provided by one of Bluetooth, RF and WiFi.

5. The water metering system of claim 1, wherein said wide area network comprises a GSM/GPRS/GPS network.

6. A water meter for metering water flowing from a water main to a water distribution system and communicating with a water consumption data collection server via a wide area network, the water meter comprising:
a power source;
an inlet connected to the water mains;
an outlet connected to the distribution system;
an impeller positioned between said inlet and said outlet wherein a speed of rotation of said impellor varies as a function of a water flow rate between said inlet and said outlet;
a sensor for measuring said speed of rotation;
circuitry for communicating via the wide area network; and
circuitry for converting said speed of rotation into a measured water consumption;
wherein said measured water consumption is transferred from time to time to the water consumption data collection server via the wide area network.

7. The water meter of claim 6, further comprising circuitry for communicating via a near field network for communicating with a gateway device.

8. The water meter of claim 7, wherein said near field network provided by one of Bluetooth, RF and WiFi.

9. The water meter of claim 7, wherein said wide area network comprises a GSM/GPRS/GPS network.

10. The water meter of claim 7, wherein said measured water consumption is transferred from time to time to the gateway device.

11. The water meter of claim 7, wherein said power source comprises at least one of a solar panel and a mains power supply.
